(19) United States
(12) Patent Application Publication
(10) Pub. No.: US 2010/0299237 A1
(43) Pub. Date: Nov. 25, 2010

(54) SYSTEM AND METHOD FOR DEFEASEMENT OF FUTURE OBLIGATIONS

(76) Inventor: Janet Leung, New Canaan, CT (US)

Correspondence Address: MORGAN LEWIS & BOCKIUS LLP, 1111 PENNSYLVANIA AVENUE NW, WASHINGTON, DC, 20004, US

(21) Appl. No.: 12/509,986

(22) Filed: Jul. 27, 2009

Related U.S. Application Data
(60) Provisional application No. 61/179,940, filed on May 20, 2009.

(51) Int. Cl. G06Q 40/00; G06Q 20/00; G06Q 50/00

(52) U.S. Cl. 705/37

(57) ABSTRACT

The disclosed technology provides systems and methods that process and manage education savings plans involving participating institutions, institution trusts, and purchasers. The disclosed technology can communicate with participating institutions to obtain prices for qualified educational services. The disclosed technology can communicate a sale of a fraction (or more) of an educational unit to a purchaser, where the sale price is based on the price for qualified educational services at a particular participating institution. Each educational unit corresponds to a right to receive qualified educational services. The disclosed technology can communicate an instruction to the particular participating institution to transfer a number of cancelable interests to a corresponding institution trust, where the number of cancelable interests corresponds to the number of educational units in the sale. The cancelable interests correspond to an obligation to provide qualified educational services at the particular participating institution. The disclosed technology can store the above information in a database.

### CROSS-REFERENCE TO RELATED APPLICATIONS

This application claims priority to U.S. Provisional Application No. 61/179,940, filed May 20, 2009, the entire contents of which are hereby incorporated herein by reference.

### FIELD OF THE INVENTION

The present invention relates to the field of information processing and management, and more specifically, to systems and method for processing and managing information relating to educational savings plans.

### BACKGROUND

A “529 plan” is a tax-advantaged investment vehicle in the United States designed to encourage saving for the future higher education expenses of a designated beneficiary.

529 plans are named after section 529 of the Internal Revenue Code, 26 U.S.C. §529. There currently are two types of 529 plans: prepaid and savings. Prepaid plans allow one to purchase tuition credits, at today's rates, to be used in the future. Savings plans are different in that all growth is based upon market performance of the underlying investments, which typically consist of mutual funds.

Prepaid plans may be administered by states, higher education institutions, or others. Savings plans may only be administered by states. Although states administer savings plans, record-keeping and administrative services for many savings plans are performed by a mutual fund company or other financial services company.

Money from a 529 plan can be used for tuition, fees, books, supplies and equipment required for study at any accredited college, university or vocational school in the United States and at some foreign universities. The money can also be used for room and board, as long as the fund beneficiary is at least a half-time student. Off-campus housing costs are covered up to the allowance for room and board that the college includes in its cost of attendance for federal financial-aid purposes.

To date families have generally adopted a stock market based approach to college savings in an attempt to keep pace with college costs inflation. As the recent stock market decline has demonstrated, families over-exposed to stock market returns can become severely under-funded in their college savings plans. Further, an equity markets based investment approach can exacerbate a family's exposure to an economic downturn; recent experience has shown that losses in college savings plans are closely correlated with declines in income, family savings, home equity, and borrowing power.

Considering the direct and indirect risks associated with conventional college savings methods, there is little reason to conclude that an equity markets based approach is the most suitable savings strategy.

There have been other systems that purport to be applicable to prepayment of college tuition. For example, U.S. patent application Ser. No. 09/837,279 (Pub. No. 2002/0004782, to Cincotta) describes a system which gathers information from potential students. It is then asserted that this information can be used to establish a probability that a particular student will attend a particular university. In this way, the system will know how much tuition to buy at a particular university presently for future delivery of educational services. This system is deficient for many reasons. The primary deficiency is the unlikely ability in Cincotta to actually determine the amount of prepaid services to purchase. Due to the massive uncertainty surrounding these decisions on when or where to attend a particular university, the probabilistic approach has little chance of effectively “hedging” future college expenses. The disclosed technology does not suffer from this uncertainty because it does not attempt to establish particular probabilities. Furthermore, colleges that participate in the plan described in Cincotta do not have immediate access to or control over savings plan funds and how they are invested or used. Therefore, colleges derive fewer benefits from that plan. The technology disclosed herein addresses these deficiencies.

Another approach to prepaying college expenses has been used by Independent 529 plan (www dot Independent529Plan dot org), operated and administered by Tuition Plan, Inc. That plan enables families to purchase tuition expenses today in return for “certificates” representing educational services of a set number of universities (approximately 270 as of 2009). The fundamental flaw to this approach is the low return a beneficiary receives if he attends a university outside the plan. In such a case, the beneficiary's return is limited to 2% per year; a return insufficient to meet rising college costs. Further, colleges do not benefit from the plan payments prior to matriculation—that is, the college cannot access funds from the plan until the beneficiary actually enrolls in that college. The technology disclosed herein also addresses these deficiencies.

Considering the direct and indirect risks associated with conventional college savings methods, there is little reason to conclude that an equity markets based approach is the most suitable savings strategy. Existing savings plans include many deficiencies, as described above. Accordingly, there is continued interest in developing an educational savings plan that adequately addresses the concerns of students and colleges, and in developing systems and methods for processing and managing information related to such an education savings plan.

### SUMMARY OF THE INVENTION

The disclosed technology provides systems and methods that process and manage education savings plans. As used herein, the terms “school”, “college”, “university”, “educational institution”, “plan institution”, “participating institution”, and “preferred institution” will be used interchangeably. The terms “student”, “participant”, “purchaser”, and “beneficiary” will also be used interchangeably and, for ease of explanation, these terms will also be used to cover persons or entities acting or making payment on behalf of a student, such as a student's parents or guardians and their banking institutions.

In one aspect of the disclosed technology, a computer can execute software for managing an education funding plan involving participating institutions, institution trusts, and purchasers. When executed by the computer, the software can cause the computer to communicate with participating institutions to obtain prices for qualified educational services at the participating institutions. The computer can communicate a sale of a fraction (or more) of an educational unit to a purchaser, where the sale price can be based on the price for qualified educational services at the particular participating institution. Each educational unit can correspond to a right to receive qualified educational services at a particular participating institution. The computer can communicate an instruction to the particular participating institution to transfer a number of cancelable interests to a corresponding institution trust, where the number of cancelable interests can corresponds to the number of educational units from the sale. Each cancelable interest can correspond to an obligation to provide qualified educational services at the particular participating institution. The computer can store, in a database, a record that specifies the purchaser, the particular participating institution, the number of educational units in the sale, and the number of cancelable interests.

One aspect of the disclosed technology provides a computer implemented method for managing an education funding plan involving a plurality of participating institutions, institution trusts, and purchasers. The computer implemented method includes electronically communicating, by a computer, with participating institutions to obtain prices for qualified educational services at the participating institutions. The computer implemented method can include electronically communicating, by the computer, a sale of a fraction (or more) of an educational unit to a purchaser, where a price of said sale is based on a price for qualified educational services at a particular participating institution. Each educational unit can correspond to a right to receive qualified educational services at a particular participating institution. The computer implemented method can include electronically communicating, by the computer, an instruction to the particular participating institution to transfer a number of cancelable interests to a corresponding institution trust, where the number of cancelable interests corresponds to the number of educational units in the sale. Each cancelable interest can correspond to an obligation to provide qualified educational services at the particular participating institution. The computer implemented method can include storing, in a database, an electronic record that specifies the purchaser, the particular participating institution, the number of educational units, and the number of cancelable interests.

Other features and advantages of the disclosed technology will become more apparent when considered in connection with the accompany drawings and detailed description.

### BRIEF DESCRIPTION OF THE DRAWINGS

In the drawings:

FIG. 1 is a block diagram of an exemplary arrangement of entities and their interactions under the disclosed technology;

FIG. 2 is a block diagram of another exemplary arrangement of entities that includes a state savings plan sponsored by a state;

FIG. 3 is a block diagram of exemplary computations and interactions between various entities shown in FIGS. 1 and 2;

FIG. 4 is a block diagram of an exemplary operation of the disclosed technology;

FIG. 5 is a block diagram of another exemplary operation of the disclosed technology that follows the operation of FIG. 4; and

FIG. 6 is a block diagram of exemplary inputs to and outputs from the various entities shown in FIGS. 1 and 2.

### DETAILED DESCRIPTION

The disclosed technology provides systems and methods that process and manage education savings plans. As used herein, the terms “school”, “college”, “university”, “educational institution”, “plan institution”, “participating institution”, and “preferred institution” will be used interchangeably. The terms “student”, “participant”, “purchaser”, and “beneficiary” will also be used interchangeably and, for ease of explanation, these terms will also be used to cover persons or entities acting or making payment on behalf of a student, such as a student's parents or guardians and the parent/guardian's banking institutions.

An exemplary embodiment of the present invention processes education services payments (such as tuition) to colleges and universities (the “plan institutions”), gathers information about potential students for the plan institutions and serves as an interface with the underlying legal entities, families and/or the related beneficiary (the “beneficiary”). As will be clear from the description below, various embodiments of the invention comprise computer-implemented methods and related computer systems and networks.

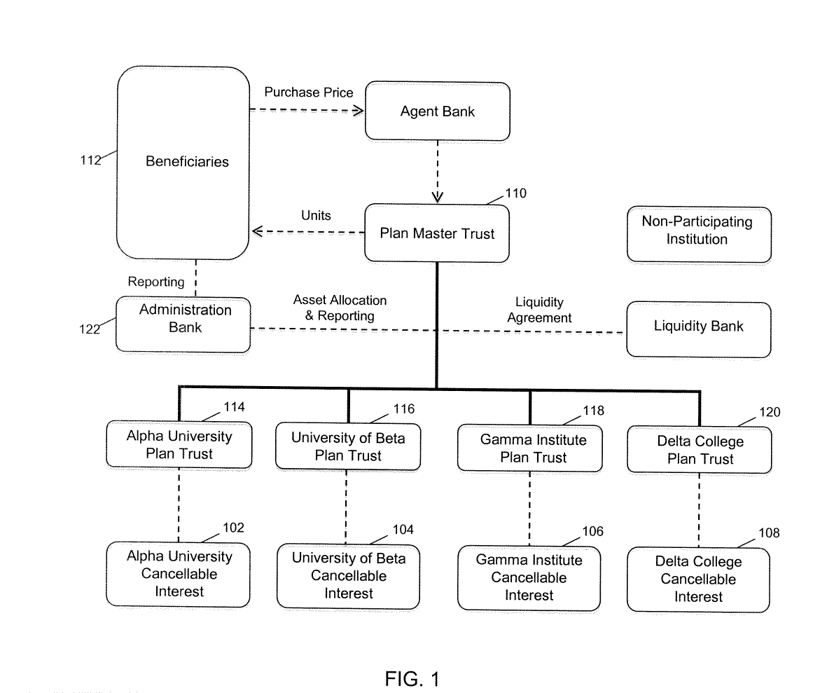

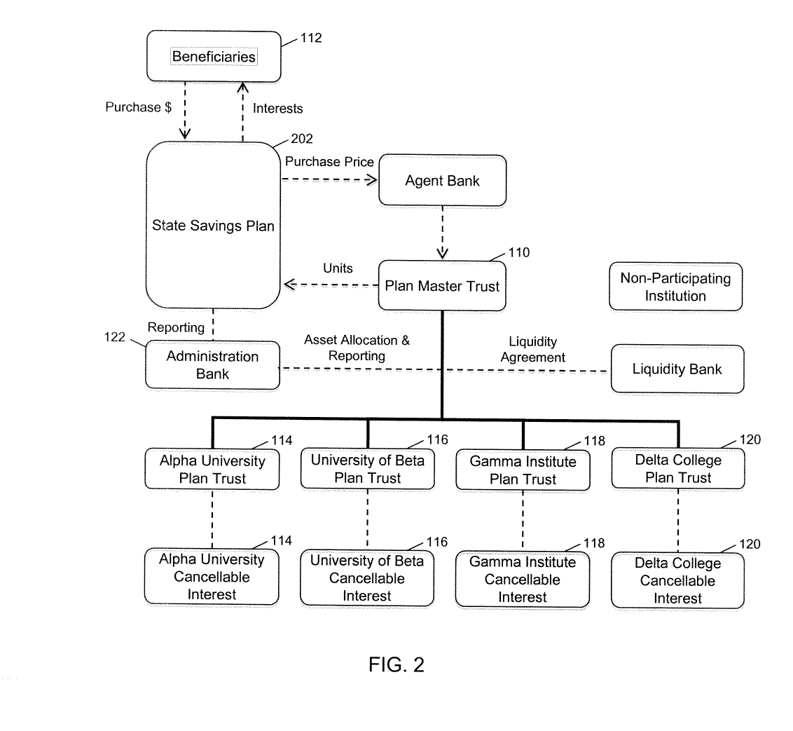

Exemplary embodiments of the present invention entail administration of a Direct College Tuition Plan (the “plan”) to address the deficiencies described above in traditional college savings plans. The plan may be implemented as either a prepaid plan or a savings plan. A prepaid plan will be described herein with respect to FIG. 1 and a savings plan will be described with respect to FIG. 2.

Under the plan, plan institutions will accept plan payments from families and, in return, provide qualified tuition services, room and board and other educational services fees (“qualified educational services”) or the cash value thereof. Through the systems and methods embodied in what will be referred to below as “stage one” and “stage two,” the plan will cause upfront plan payments from students to be directed to colleges or universities for their unrestricted use.

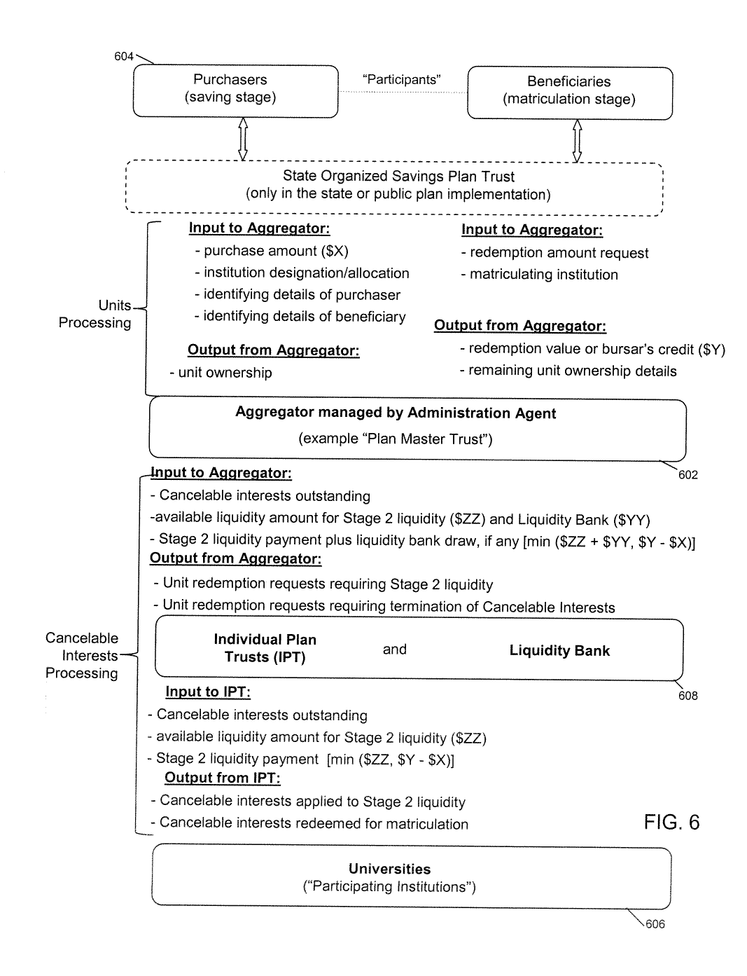

The disclosed technology will now be described with reference to FIG. 1. The plan is designed to accurately match a family's cost of college savings with future college costs. By using an interface provided by an exemplary embodiment of the invention (described in FIG. 6), families 112 will choose a favored school or schools (each, a “preferred institution”) 102-108 and indicate how much money should be allocated to each preferred institution 102-108. Alternatively, money may be allocated proportionally across a number of preferred institutions 102-108 automatically by the interface provided by an exemplary embodiment of the invention (FIG. 6); proportional allocation may be implemented with respect to the relative sizes or costs of the respective preferred institutions. The preferred institutions 102-108 also will interface with the plan administrator 110 to determine the number of interests/education units (e.g., credits, or certificates—the “cancelable interests” as further described below) that will be issued that represent a proportion of qualified educational services.

In addition to interfacing with beneficiaries 112 and preferred institutions 102-108, a plan administrator will connect a trust or other legal entity 110 and its administration bank 122 (the “plan master trust” 110 and “administration bank” 122 respectively) with a number of individual plan trusts or other legal entities 114-120 established by plan institutions and their administration bank(s) (the “individual plan trusts” 114-120). Beneficiaries 112 may have a direct interest in the plan master trust 110 (FIG. 1) or beneficiaries may have an indirect interest in the plan master trust (FIG. 2); for example in a 529 savings plan implementation as shown in FIG. 2, beneficiaries 112 will acquire an indirect interest in the plan master trust 110 through a contribution to a state sponsored 529 savings plan 202. Each individual plan trust 114-120 will hold cancelable interests issued by the related plan institution 102-108. In return for issuing the cancelable interests -- which entitle the beneficiary 112 thereof to a proportion of qualified educational services -- the related plan institution 102-108 will receive cash from the individual plan trust 114-120.

Families 112 that participate in the plan will purchase units of the plan master trust 110 (the “units”) related to a particular preferred institution 102-108. Alternatively, families 112 may purchase shares or interests in other investment vehicles (e.g., 202, FIG. 2) which hold the unit interest (i.e. an indirect holding). For example, in a 529 savings plan implementation of the invention, a state sponsored plan or entity 202 will hold the units on behalf of the beneficiaries 112. The purchase price for those units will go first to the plan master trust 110; then to the individual plan trust 114-120, related to a particular preferred institution 102-108 (in return for interests in such individual plan trust); then to the related preferred institution 102-108 in return for cancelable interests.

The activities of the plan master trust 110 and the individual plan trusts 114-120 will be managed by the administration bank 122 in accordance with their respective operative documents. The plan master trust 110 and individual plan trusts 114-120 will be organized in accordance with a “qualified tuition program” under section 529 of the U.S. Tax Code.

A risk in prepaying college tuition is admission uncertainty: the purchase of units does not guarantee entry into a preferred institution 102-108. Therefore, a number of beneficiaries 112 likely will not attend their preferred institution 102-108 due to admissions outcomes. In addition, revised preferences or other family considerations may cause a beneficiary 112 to attend a different institution, or no institution at all.

The operation of a settlement algorithm employed in one or more exemplary embodiments of the invention addresses this uncertainty by allowing the plan to balance the objectives of both the families and the plan institutions: the plan offers families portability similar to a conventional savings 529 Plan, and the plan allows the plan institutions to access and use the amounts received from families immediately.

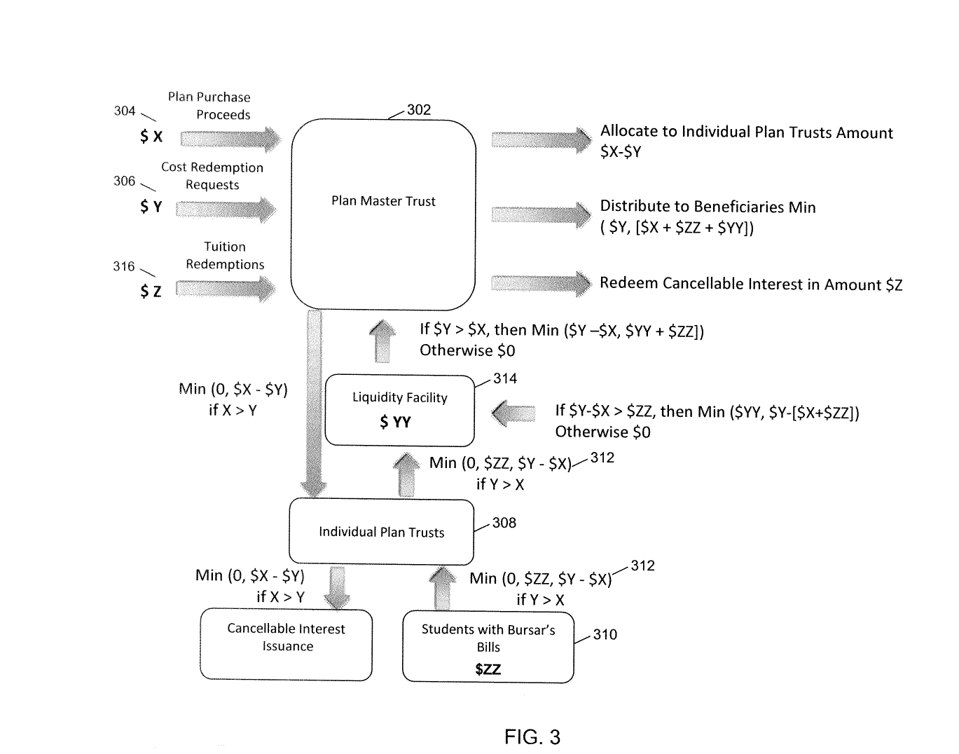

Exemplary embodiments of the invention utilize different layers of protection to address admission uncertainty. These aspects are referred to as “stage one” and “stage two” and will be described below with reference to FIG. 3.

A description of stage one follows. On each unit issuance date, the plan master trust 302 will automatically offset new unit purchase proceeds 304 related to a preferred institution against amounts due from an individual plan trust (because a beneficiary is exiting the plan or attending a different institution 306) relating to underlying cancelable interests issued by that preferred institution. This offset mechanism has the effect of creating a seamless exchange (of individual plan trust benefits) between new holders of units relating to a specific preferred institution and exiting unit holders relating to that preferred institution.

A description of stage two follows. If Stage One is not available or if cost redemption requests 306 involves an amount greater than the amount of plan purchase proceeds 304, the plan (i.e., the plan administration system and software) 302 will indicate to an individual plan trust 308 to sell cancelable interests to current or newly enrolled students 310 at the related plan institution who have current payable amounts. The individual plan trust 308 will interface with a plan institution's bursar office (not shown) to identify students with such obligations 310. The individual plan trust 308 will interface with the plan institution's bursar office to indicate a credit of that dollar amount at the plan institution's bursar office. The cash proceeds from the sale of the cancelable interests 312 will be remitted from the individual plan trust 308 to the plan master trust 302 for appropriate disbursement.

If the invention is unsuccessful in automatically offsetting as proposed in stage one and stage two, a “liquidity bank” 314 may provide funds to the appropriate individual plan trust 308, and an interest in the related cancelable interest will be automatically established for the benefit of the liquidity bank 314.

An “administration bank” will buy and sell cancelable interests (i.e., provide a source of short-term liquidity) in the event that stage two results in timing mismatches between an exiting unit-holder and an incoming student to a particular preferred institution.

The plan's offsetting mechanism is a useful feature since individuals will not be permitted to hold cancelable interests directly and units may not be transferred. Beneficiary re-designations and taxable distributions consistent with 529 plans will be accommodated.

In an exemplary embodiment, the plan administrator 302 records unit ownership, the preferred institutions indicated, the beneficiary, as well as other relevant information about such beneficiary, that might be deemed beneficial to participating institutions. In addition, the plan administrator 302 records the amount of cancelable interests issued by the respective participating institution, as well as other information relating to participating institutions that might be deemed beneficial to families and students.

Participation in the plan prepays a percentage of qualified educational services at a preferred institution or preferred institutions. Effectively, then, families have defeased a future obligation by a present payment into the plan.

By way of example, one unit may be equal to $1000 divided by the current costs for one year of qualified educational services at the preferred institution. A unit, therefore, would entitle a beneficiary to a percentage of a full year of qualified educational services at the preferred institution at any time such beneficiary is able to enroll, or a substantially equivalent cash value should such beneficiary be unable to enroll at the preferred institution.

Beneficiaries will receive the value of their units through a redemption with the plan master trust in two scenarios: either (i) a credit to their account at the preferred institution (a “Tuition Redemption” 316, FIG. 3), or (ii) a cash distribution to be applied to educational costs at a different institution (a “Cost Redemption” 306, FIG. 3). The related index unit values may be as follows:

Tuition Redemption: For a unit, the percentage of annual qualified educational services at the preferred institution originally purchased.

Cost Redemption: For a unit the fair market value of the Tuition Redemption.

In each case, the cost of qualified educational services is calculated on the basis of qualifying tuition, room and board, and mandatory fees charged to a hypothetical student without regard to any scholarships or other aid.

### EXAMPLE

| | | Cost of preferred | |
|---|---|---|---|
| Purchase History | Amount | institution QES | Units |
| August 2009 | $10,000 | $20,000 | 0.5 |
| August 2010 | $10,000 | $20,600 | 0.485 |
| August 2011 | $10,000 | $21,630 | 0.462 |

Referring again to FIG. 1, each plan payment is sent via the administration bank (or other plan administrator) 122 to the plan master trust 110. The beneficiaries 122 will then hold units referencing their particular preferred institution or institutions 102-108. The plan master trust 110 (again, through the administration bank 122) will purchase interests in the related individual plan trust 114-120 (i.e., money to the individual plan trust, interests to the plan master trust). Finally, the individual plan trust 114-120 will (through the administration bank) send payment to the preferred institution 102-108 in return for cancelable interests. In one embodiment, this money flow preferably occurs within 3 business days of a purchase of the units on behalf of the beneficiaries. So in this example, the university will gain unrestricted use of $10,000 on each of August 2009, 2010, and 2011.

If the beneficiary 112 enrolled at the preferred institution in 2012 (i.e., executed a Tuition Redemption), the units would entitle the beneficiary to one full year of qualified educational services plus 44.7% of the cost of an additional year of qualified educational services. If the beneficiary 112 did not enroll at the preferred institution (i.e., a Cost Redemption) and assuming the cost of the preferred institution's qualified educational services increased 4% from 2011 to 2012 (to $22,495) the beneficiary's account (i.e., 144.7 units) will be worth $32,550 (1.447 times $22,495) as of August 2012.

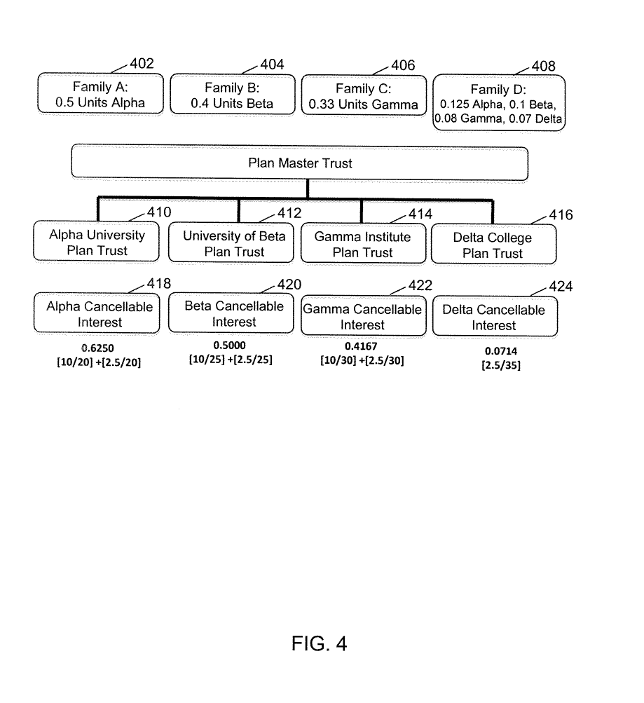

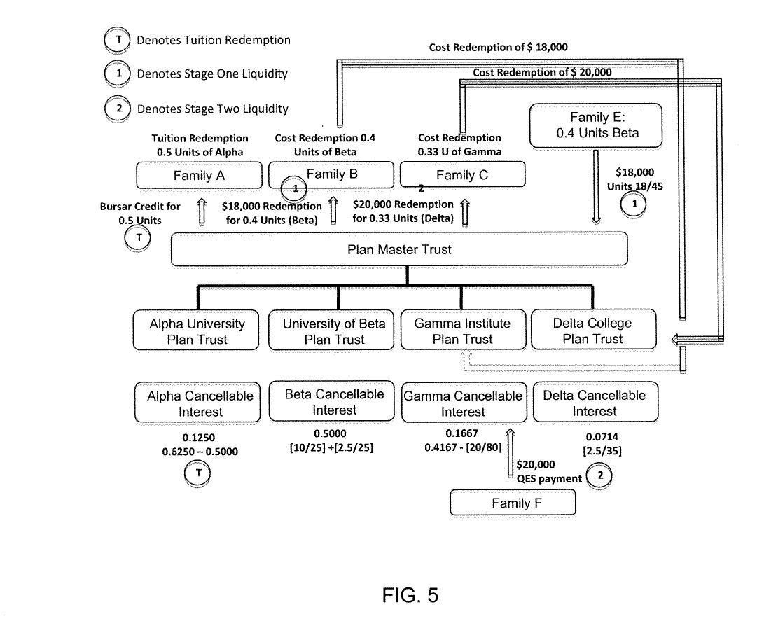

FIG. 4 and FIG. 5 illustrate additional examples. FIG. 4 shows the transactions at the inception of the plan for four families wishing to save for future education costs. For the purpose of this example, suppose:
1. The families, A, B, C and D decide to participate by purchasing $10,000 each.
2. Families A, B and C choose Alpha University, University of Beta and Gamma Institute, respectively, for their preferred institution.
3. Family D decides to allocate $2,500 to each institution as a preferred institution
   Additionally, suppose at inception of the plan one year of qualified educational services costs:

Alpha University: $20,000

University of Beta: $25,000

Gamma Institute: $30,000

Delta College: $35,000.

In this example, then, the families 402-408 will be beneficiaries of the number of units shown in FIG. 4, and the educational institutions will have issued corresponding cancelable interests 418-424 in the amounts shown in FIG. 4.

Referring now to FIG. 5, suppose after 10 years, the Families decide as follows:

Family A redeems units for Qualified Educational Expenses at Alpha University;

Family B redeems units for Qualified Educational Expenses at Gamma Institute;

Family C redeems units for Qualified Educational Expenses at Delta College; and

Family D remains in program

Family E purchases 0.4 units o f Beta for $18,000

Family F attends Gamma with no participation in plan and pays partial QES of $20,000

Also, after 10 years, one year of qualified educational services is as follows:

Alpha University: $30,000

University of Beta: $45,000

Gamma Institute: $60,000

Delta College: $80,000

Then the flow of funds and resulting changes in number of units and cancelable interests are as shown in FIG. 5.

In an exemplary embodiment, the plan's software allows families to see how many years or portions thereof have been accumulated for each institution. In addition, the plan provides information describing the then-current cash value of units held by each family. This provides precise information as to the ultimate amount saved and needed to be saved for college education.

Referring now to FIG. 6, there is shown a block diagram of exemplary inputs to and output from various entities. A computer implemented method and system implemented at the administrator agent/plan master trust will be referred to herein as “aggregator” 602. The aggregator enables (i) purchasers of prepaid services (hereinafter, the “purchasers” 604) to realize the future value of those prepaid services in cash or for use at other services providers; and (ii) sellers of prepaid services (hereinafter, the “participating institutions” 606) to generate cash in return for an obligation to return services (hereinafter, “qualified educational services”) at a later date.

The aggregator 602 can include an electronic processing system (such as a computer) that interfaces with a number of participating institutions 606 (or their computers) that will sell rights to receive services (hereinafter, “cancelable interests”) to an entity or certain entities (hereinafter, “Individual Trusts” 608). The aggregator 602 will maintain a database of the current price for qualified educational services at participating institutions 606. The aggregator 602 will sell interests or units (hereinafter, “educational units”) on behalf of the plan master trust to purchasers 604. Each educational unit corresponds to a cancelable interest and represents a right to receive qualified educational services at a participating institution 606. Based on the price for qualified educational services at the participating institutions stored and continually updated in the aggregator, the aggregator will determine a price for the corresponding educational units.

In one aspect of the disclosed technology, the aggregator 602 that can receive requests from purchasers 604 for the purchase of educational units. The aggregator 602 will store a record indicating that it should, in return for payment, which price is computed and stored by the aggregator, deliver an educational unit or units to such purchaser or purchasers 604. The aggregator 602 will maintain a database of all such educational units sold and the participating institution to which such educational units relate. The aggregator will communicate an instruction to deliver the proceeds from the educational units sold to the appropriate individual plan trust 608. The aggregator will communicate instructions to such individual plan trust 608 to enable it to further deliver such proceeds to the appropriate participating institution 606. The aggregator can also communicate instructions to the appropriate participating school 606 to deliver the appropriate amount, which will be computed and stored in the aggregator, of cancelable interests to such individual plan trust 608.

In one aspect of the disclosed technology, the aggregator 602 will periodically receive data from participating institutions 606 relating to the current price for qualified educational services at the participating institutions. Using such price information, the aggregator 602 can periodically compute the value of educational units held by the purchasers 604. The aggregator can provide such information to purchasers 604 through, for example, a website. In some embodiments, the aggregator 602 can collect other miscellaneous information from participating institutions 606 and from purchasers 604 and communicate such information between them to the extent that it desired.

In one aspect of the disclosed technology, the aggregator 602 will receive requests from purchasers 604 for the redemption of their educational units (“redeeming purchasers”). After receiving such request for redemption, the aggregator 602 can search its database for other purchasers who have sent requests to purchase the same type of educational units (an “offsetting unit purchaser”) (not shown). If an offsetting unit purchaser is found by the aggregator 602, the aggregator 602 will store a record indicating that it should, in return for payment, which price is computed and stored by the aggregator, deliver an educational unit or units to such offsetting unit purchaser. The aggregator 602 will communicate instructions (to a banking institution) to deliver to the redeeming purchasers the proceeds from the educational units sold to the offsetting unit purchaser. The aggregator 602 will update its data to reflect that the offsetting purchaser now owns such educational units and that those educational units will correspond to the appropriate cancelable interests.

If, after receiving a request for redemption, an offsetting unit purchaser is not found, the aggregator can interface with the participating institution to which the redemption units relate. The aggregator will instruct the participating institution 606 to search for current service purchasers who have or will be billed by the participating institution (such as incoming students or existing students) and to provide that information to the aggregator 602. The aggregator will instruct the participating institution 606 to remit proceeds from the incoming students/existing students to the individual plan trust 608. In accordance with such remittal, the aggregator will store a record canceling the cancelable interest relating to the redeeming purchaser's educational units, instruct the individual plan trust 608 to remit those proceeds to the master trust's banking institution, and instruct the Master Trust banking institution to remit those proceeds to the redeeming purchaser.

If, after receiving a request for redemption, an offsetting unit purchaser is not found and an incoming student's bill is not yet due, the aggregator 602 can interface with a liquidity provider (a “liquidity provider”). The aggregator 602 will provide data to the liquidity provider concerning such educational units, which data may include details on the participating institution, the billing cycle of the participating institution, the number of incoming students expected at such participating institution as well as other information as the liquidity provider may deem necessary or desirable. If the liquidity provider consents, the aggregator will send a request for the delivery, to the individual plan trust banking institution, of proceeds equal to the value (such value stored and periodically updated in the aggregator) of such education units that are to be redeemed. With receipt of such proceeds by the individual plan trust 608, the aggregator 602 will assign the related cancelable interest to the liquidity provider.

In one embodiment, the aggregator 602 can periodically communicate with the participating institution 606 to determine when payment is received from the incoming students. After such payment is received, the aggregator 602 can instruct the participating institution 606 to remit such proceeds to the liquidity provider, and the aggregator can then cancel the related cancelable interest.

What have been described are systems and methods that process and manage an educational savings plan in accordance with the disclosed technology. Various embodiments of the disclosed technology have been described herein, and various embodiments are described below. The embodiments should not be considered to be mutually exclusive. It is contemplated that various embodiments can be combined.

In one aspect of the disclosed technology, a computer can execute software for managing an education funding plan involving participating institutions, institution trusts, and purchasers. When executed by the computer, the software can cause the computer to communicate with participating institutions to obtain prices for qualified educational services at the participating institutions. The computer can communicate a sale of a fraction (or more) of an educational unit to a purchaser, where the sale price can be based on the price for qualified educational services at the particular participating institution. Each educational unit can correspond to a right to receive qualified educational services at a particular participating institution. The computer can communicate an instruction to the particular participating institution to transfer a number of cancelable interests to a corresponding institution trust, where the number of cancelable interests can corresponds to the number of educational units from the sale. Each cancelable interest can correspond to an obligation to provide qualified educational services at the particular participating institution. The computer can store, in a database, a record that specifies the purchaser, the particular participating institution, the number of educational units in the sale, and the number of cancelable interests. In one embodiment, the purchaser can be a student, an entity acting on behalf of a student, or a state savings plan.

In one embodiment, the computer can receive an indication that the purchaser has made payment on said sale. The software can cause the computer to communicate an instruction to transfer that payment to the corresponding institution trust, and communicate an instruction for the corresponding institution trust to transfer the payment to the particular participating institution.

In one embodiment, the computer periodically communicates with the particular participating institution to obtain an updated price for qualified educational services at the particular participating institution. The computer can compute the current value of the number of educational units stored in said record based on the updated price, and store the computed current value in the record.

In one aspect of the disclosed technology, the computer can receive a request from the purchaser to redeem the educational units. In one embodiment, the computer can perform a search for requests from at least one offsetting purchaser to purchase educational units for the particular participating institution.

In one embodiment, the computer can receive an indication that one or more offsetting purchasers have made payment on purchase of educational units for the particular participating institution, modify the record (in the database) to replace the purchaser with the offsetting purchaser, and communicate an instruction to transfer to the purchaser the payment from the one or more offsetting purchasers.

In one embodiment, the computer can receive an indication that a portion (or more) of the educational units have not been offset. The computer can communicate an instruction to the particular participating institution to search for purchasers of educational service at the particular participating institution. The computer can receive from the particular participating institution proceeds from those purchasers of educational service at the particular participating institution, where the proceeds can be transferred through the corresponding institution trust. The computer can communicate an instruction to transfer the received proceeds to the purchaser, and can communicate an instruction to the particular participating institution to cancel the number of cancelable interests previously associated with the purchaser. In one embodiment, the purchasers of educational service at the particular participating institution are incoming students.

In one embodiment, the computer can receive from the particular participating institution an indication that purchasers of educational service will be available at a future date. The computer can receive from a liquidity provider temporary funds equal to a current value of the number of educational units, communicate an instruction to transfer the temporary funds to the purchaser, and modifying the record (in the database) to replace the purchaser with the liquidity provider. In one embodiment, the computer can later receive an indication from the particular participating institution that proceeds from the purchasers of educational service are available, communicate an instruction to the particular participating institution to transfer those proceeds to the liquidity bank, wherein the proceeds are transferred through the corresponding institution trust, and communicate an instruction to the particular participating institution to cancel the number of cancelable interests.

Aspects of the disclosed technology provide computer implemented methods in accordance with one or more of the aspects and embodiments described above.

One aspect of the disclosed technology provides a computer implemented method for managing an education funding plan involving a plurality of participating institutions, institution trusts, and purchasers. The computer implemented method includes electronically communicating, by a computer, with participating institutions to obtain prices for qualified educational services at the participating institutions. The computer implemented method can include electronically communicating, by the computer, a sale of a fraction (or more) of an educational unit to a purchaser, where a price of said sale is based on a price for qualified educational services at a particular participating institution. Each educational unit can correspond to a right to receive qualified educational services at a particular participating institution. The computer implemented method can include electronically communicating, by the computer, an instruction to the particular participating institution to transfer a number of cancelable interests to a corresponding institution trust, where the number of cancelable interests corresponds to the number of educational units in the sale. Each cancelable interest can correspond to an obligation to provide qualified educational services at the particular participating institution. The computer implemented method can include storing, in a database, an electronic record that specifies the purchaser, the particular participating institution, the number of educational units, and the number of cancelable interests. In one embodiment, the purchaser can be a student, an entity acting on behalf of a student, or a state savings plan.

In one embodiment, the computer implemented method can include receiving an electronic indication that the purchaser has made payment on the sale. The computer implemented method can include electronically communicating, by the computer, an instruction to transfer that payment to the corresponding institution trust, and electronically communicating, by the computer, an instruction for the corresponding institution trust to transfer the payment to the particular participating institution.

In one embodiment, the computer implemented method can include periodically communicating with the particular participating institution to obtain an updated price for qualified educational services at the particular participating institution, computing, by the computer, a current value of the number of educational units stored in the electronic record based on the updated price, and storing the current value in the electronic record.

In one embodiment, the computer implemented method can include electronically receiving a request from the purchaser to redeem the educational units. The computer implemented method can include performing, by the computer, a search for requests from one or more offsetting purchasers to purchase educational units for the particular participating institution.

In one embodiment, the computer implemented method can include receiving an electronic indication that one or more offsetting purchasers have made payment on purchase of educational units for the particular participating institution. The computer implemented method can include modifying the electronic record (in the database) to replace the purchaser with the offsetting purchaser, and electronically communicating, by the computer, an instruction to transfer to the purchaser the payment from the one or more offsetting purchasers.

In one embodiment, the computer implemented method can include receiving an electronic indication that a portion (or more) of the educational units have not been offset. The computer implemented method can include electronically communicating, by the computer, an instruction to the particular participating institution to search for purchasers of educational service at the particular participating institution. The computer implemented method can include receiving from the particular participating institution proceeds from the purchasers of educational service at the particular participating institution, where the proceeds are transferred through the corresponding institution trust. The computer implemented method can include electronically communicating, by the computer, an instruction to transfer the received proceeds to the purchaser, and electronically communicating, by the computer, an instruction to the particular participating institution to cancel the number of cancelable interests previously associated with the purchaser. In one embodiment, purchasers of educational service at the particular participating institution are incoming students.

In one embodiment, the computer implemented method can include receiving from the particular participating institution an electronic indication that purchasers of educational service will be available at a future date. The computer implemented method can include receiving from a liquidity provider temporary funds equal to a current value of the number of educational units, and electronically communicating, by the computer, an instruction to transfer those temporary funds to the purchaser. The computer implemented method can include modifying the electronic record (in the database) to replace the purchaser with the liquidity provider. In one embodiment, the computer implemented method can include later receiving an electronic indication from the particular participating institution that proceeds from the purchasers of educational service are available. The computer implemented method can include electronically communicating, by the computer, an instruction to the particular participating institution to transfer the proceeds to the liquidity bank, where the proceeds are transferred through the corresponding institution trust, and electronically communicating, by the computer, an instruction to the particular participating institution to cancel the number of cancelable interests.

Embodiments of the present invention comprise software and computer components and software and computer-implemented steps that will be apparent to those skilled in the art. For ease of exposition, not every step or element of the present invention is described herein as part of software or computer system, but those skilled in the art will recognize that each step or element may have a corresponding computer system or software component. Such computer system and/or software components are therefore enabled by describing their corresponding steps or elements (that is, their functionality), and are within the scope of the present invention.

It will be appreciated that the present invention has been described by way of example, and that the invention is not to be limited by the specific embodiments described herein. Improvements and/or modifications may be made to the invention without departing from the scope or spirit thereof.

What is claimed is:

1. A computer executing software for managing an education funding plan involving a plurality of participating institutions, institution trusts, and purchasers, wherein the software, when executed by the computer, causes the computer to perform steps comprising:
communicating with a plurality of participating institutions to obtain prices for qualified educational services at said plurality of participating institutions;
communicating a sale of at least a fraction of an educational unit to a purchaser, wherein each educational unit corresponds to a right to receive qualified educational services at a particular participating institution, and wherein a price of said sale is based on a price for qualified educational services at a particular participating institution;
communicating an instruction to said particular participating institution to transfer a number of cancelable interests to a corresponding institution trust, wherein said cancelable interests correspond to an obligation to provide qualified educational services at said particular participating institution, and wherein said number of cancelable interests corresponds to said number of educational units in said sale; and
storing, in a database, a record that specifies said purchaser, said particular participating institution, a number of educational units in said sale, and said number of cancelable interests.

2. A computer executing software as in claim 1, wherein the software, when executed by the computer, causes the computer to perform further steps comprising:
receiving an indication that said purchaser has made payment on said sale;
communicating an instruction to transfer said payment to said corresponding institution trust; and
communicating an instruction for said corresponding institution trust to transfer said payment to said particular participating institution.

3. A computer executing software as in claim 1, wherein said purchaser is one of: a student, an entity acting on behalf of a student, or a state savings plan.

4. A computer executing software as in claim 1, wherein the software, when executed by the computer, causes the computer to perform further steps comprising:
periodically communicating with said particular participating institution to obtain an updated price for qualified educational services at said particular participating institution;
computing a current value of said number of educational units stored in said record based on said updated price; and
storing said current value of said number of educational units in said record.

5. A computer executing software as in claim 1, wherein the software, when executed by the computer, causes the computer to perform further steps comprising:
receiving a request from said purchaser to redeem said educational units; and
performing a search for requests to purchase educational units for said particular participating institution from at least one offsetting purchaser.

6. A computer executing software as in claim 5, wherein the software, when executed by the computer, causes the computer to perform further steps comprising:
receiving an indication that at least one offsetting purchaser has made payment on purchase of educational units for said particular participating institution;
modifying, in said database, said record to replace said purchaser with said offsetting purchaser; and
communicating an instruction to transfer to said purchaser said payment from said at least one offsetting purchaser.

7. A computer executing software as in claim 5, wherein the software, when executed by the computer, causes the computer to perform further steps comprising:
receiving an indication that at least a portion of said educational units has not been offset;
communicating an instruction to said particular participating institution to search for purchasers of educational service at said particular participating institution;
receiving from said particular participating institution proceeds from said purchasers of educational service, wherein said proceeds are transferred through said corresponding institution trust;
communicating an instruction to transfer said received proceeds to said purchaser; and
communicating an instruction to said particular participating institution to cancel said number of cancelable interests.

8. A computer executing software as in claim 7, wherein said purchasers of educational service at said particular participating institution are incoming students.

9. A computer executing software as in claim 5, wherein the software, when executed by the computer, causes the computer to perform further steps comprising:
receiving an indication that at least a portion of said educational units has not been offset;
communicating an instruction to said particular participating institution to search for purchasers of educational service at said particular participating institution;
receiving from said particular participating institution an indication that purchasers of educational service will be available at a future date;
receiving from a liquidity provider temporary funds equal to a current value of said number of educational units;
communicating an instruction to transfer said temporary funds to said purchaser; and
modifying, in said database, said record to replace said purchaser with said liquidity provider.

10. A computer executing software as in claim 9, wherein the software, when executed by the computer, causes the computer to perform further steps comprising:
receiving an indication from said particular participating institution that proceeds from said purchasers of educational service are available;
communicating an instruction to said particular participating institution to transfer said proceeds to said liquidity bank, wherein said proceeds are transferred through said corresponding institution trust; and
communicating an instruction to said particular participating institution to cancel said number of cancelable interests.

11. A computer implemented method for managing an education funding plan involving a plurality of participating institutions, institution trusts, and purchasers, the method comprising:
electronically communicating, by a computer, with a plurality of participating institutions to obtain prices for qualified educational services at said plurality of participating institutions;
electronically communicating, by said computer, a sale of at least a fraction of an educational unit to a purchaser, wherein each educational unit corresponds to a right to receive qualified educational services at a particular participating institution, and wherein a price of said sale is based on a price for qualified educational services at a particular participating institution;
electronically communicating, by said computer, an instruction to said particular participating institution to transfer a number of cancelable interests to a corresponding institution trust, wherein said cancelable interests correspond to an obligation to provide qualified educational services at said particular participating institution, and wherein said number of cancelable interests corresponds to said number of educational units in said sale; and
storing, in a database, an electronic record that specifies said purchaser, said particular participating institution, a number of educational units in said sale, and said number of cancelable interests.

12. A computer implemented method as in claim 11, further comprising:
receiving an electronic indication that said purchaser has made payment on said sale;
electronically communicating, by said computer, an instruction to transfer said payment to said corresponding institution trust; and
electronically communicating, by said computer, an instruction for said corresponding institution trust to transfer said payment to said particular participating institution.

13. A computer implemented method as in claim 11, wherein said purchaser is one of: a student, an entity acting on behalf of a student, or a state savings plan.

14. A computer implemented method as in claim 11, further comprising:
periodically communicating with said particular participating institution to obtain an updated price for qualified educational services at said particular participating institution;
computing, by said computer, a current value of said number of educational units stored in said electronic record based on said updated price; and
storing said current value of said number of educational units in said electronic record.

15. A computer implemented method as in claim 11, further comprising:
electronically receiving a request from said purchaser to redeem said educational units; and
performing, by said computer, a search for requests to purchase educational units for said particular participating institution from at least one offsetting purchaser.

16. A computer implemented method as in claim 15, further comprising:
receiving an electronic indication that at least one offsetting purchaser has made payment on purchase of educational units for said particular participating institution;
modifying, in said database, said electronic record to replace said purchaser with said offsetting purchaser; and
electronically communicating, by said computer, an instruction to transfer to said purchaser said payment from said at least one offsetting purchaser.

17. A computer implemented method as in claim 15, further comprising:
receiving an electronic indication that at least a portion of said educational units has not been offset;
electronically communicating, by said computer, an instruction to said particular participating institution to search for purchasers of educational service at said particular participating institution;
receiving from said particular participating institution proceeds from said purchasers of educational service, wherein said proceeds are transferred through said corresponding institution trust;
electronically communicating, by said computer, an instruction to transfer said received proceeds to said purchaser; and
electronically communicating, by said computer, an instruction to said particular participating institution to cancel said number of cancelable interests.

18. A computer implemented method as in claim 17, wherein said purchasers of educational service at said particular participating institution are incoming students.

19. A computer implemented method as in claim 15, further comprising:
receiving an electronic indication that at least a portion of said educational units has not been offset;
electronically communicating, by said computer, an instruction to said particular participating institution to search for purchasers of educational service at said particular participating institution;
receiving from said particular participating institution an electronic indication that purchasers of educational service will be available at a future date;
receiving from a liquidity provider temporary funds equal to a current value of said number of educational units;
electronically communicating, by said computer, an instruction to transfer said temporary funds to said purchaser; and
modifying, in said database, said electronic record to replace said purchaser with said liquidity provider.

20. A computer implemented method as in claim 19, further comprising:
receiving an electronic indication from said particular participating institution that proceeds from said purchasers of educational service are available;
electronically communicating, by said computer, an instruction to said particular participating institution to transfer said proceeds to said liquidity bank, wherein said proceeds are transferred through said corresponding institution trust; and
electronically communicating, by said computer, an instruction to said particular participating institution to cancel said number of cancelable interests.
